(19) United States
(12) Patent Application Publication
(10) Pub. No.: US 2015/0261921 A1
(43) Pub. Date: Sep. 17, 2015

(54) Virtual Identification System and Method for Patients

(71) Applicant: Virtual Health Systems Corporation, Hamilton, NJ (US)

(72) Inventor: Jacob T. Brown, JR., Hamilton, NJ (US)

(21) Appl. No.: 14/656,768

(22) Filed: Mar. 13, 2015

Related U.S. Application Data
(60) Provisional application No. 61/954,116, filed on Mar. 17, 2014.

(51) Int. Cl. G06F 19/00; G06F 21/62

(52) U.S. Cl. CPC G06F 19/322; G06F 21/6254; G06F 21/6263

(57) ABSTRACT

A virtual identification system and method allowing a patient to create and use, offline, a personal identification number to retrieve, store, and use personal health information. The patient is provided online access from a network device to health information related to the patient stored on a network server. Personal identifying information is constantly purged in the background. A translator hardware device is connected to the network server and the patient is allowed to enter the personal identification number into the translator, offline. Upon authentication by the translator, the patient is allowed to download the health information from the network server and store the health information within the translator hardware device, wherein the health information is now offline. The personal identifying information is loaded into the translator, such that the health information is coupled to the personal identifying information but still offline.

### CROSS-REFERENCE TO RELATED APPLICATIONS

The instant application claims benefit of provisional application Ser. No. 61/954,116 filed Mar. 17, 2014, the contents of which are incorporated herein by reference.

### BACKGROUND

1. Field of the Invention

The instant invention relates to the protection of individual identity, privacy, and rights from the intrusion of personal and sensitive information submitted on line and accessible via the Internet.

2. Description of the Relation Art

Internet security as it pertains to confidentiality of personal information is an oxymoron. Any information on the internet can be accessed illegally and legally, independent of encryption, HIPPA, monitoring and other techniques and procedures currently employed to provide security and protect private and sensitive information.

Using virtual entities for authentication is known in the art. U.S. Pat. No. 8,856,894 teaches the use of a virtual credential for authentication. The “always-on-authentication” system automatically monitors and authenticates an enrolled individual's online transactions, for example, to detect and/or prevent fraud. U.S. Pat. No. 8,112,405 shows network access using a virtual entity. A first data corresponds to the data of the real entity and second data corresponds to the identity of a virtual entity, linked to the real data.

Drawbacks exist in as much as the authentication step itself is done online. To protect an individual privacy or to implement other security or anonymity feature, the user is authenticated to the system, but since the system itself is for network access, the authentication process is done over a network. In this manner the virtual ID is only established after an on-line based authentication step, which itself can be compromised.

The Internet has provided hackers, governments, foreign, domestic and research corporations with basically unfettered access to any and all personal information on citizens globally (i.e., credit cards, bank accounts, user's names, passwords, health and legal information) currently contained in data bases, social media and various Internet sites.

User names and passwords are the primary facades of protection for privacy and confidentiality. Often encryption technologies are included for additional deterrence against the intrusion of privacy. These security facades are usually neutralized by various technical expertise, devices and software. Once intruders are able to circumvent these pseudo barriers of protection, they have full unfettered access to any and everyone's most personal and sensitive information. The sources that can penetrate these barriers of protection are both illegal and legal. It is impossible for anyone's personal information to remain private, confidential or secure if it is deposited on line on any site on the Internet. There is no known technology that is sufficient to protect against intrusion of information deposited on the Internet.

Virtual Identifications Procedures conceded that all Internet information is accessible. It assumes that the on line information can, and will be, accessed by a variety of sources. However if the information accessed cannot be matched to a specific person's identity, then the value of that information is diminished and the violation of the person's privacy and right of confidentiality is eliminated.

The instant system and method is a protocol to provide security and confidentiality for patients combining online techniques with offline techniques.

### SUMMARY

A user creates an alphanumeric code, or VIRTUAL ID. The code is shared solely with a health provider. The ID is associated by the health provider to the personal identification and medical information of the user which is stored on a network, typically the Internet. The ID is then substituted for the user's personal identification information as it relates to their health provider-stored information, as a result any access to the health-provider stored information, lawful or hacked/intercepted, reveals the alphanumeric code instead of personal information. Coupled to the use of a virtual ID is an offline translator hardware device for storing the health information, now retrievable by a health provider offline instead of online.

Accordingly, comprehended is a virtual identification method, comprising the steps of allowing a patient to create, offline, a personal identification number (V-ID). The patient is provided online access from a network device to health information (V-ID information) related to the patient stored on a network server. Personal identifying information is constantly purged in the background of the network server. A translator hardware device is connected to the network server and the patient is allowed to enter the personal identification number (V-ID) into the translator, wherein the pin is therefore provided offline. Since the translator is in communication with the network server, upon authentication by the translator, the patient is allowed to download the health information from the network server and store the health information within the translator hardware device, wherein the health information is now offline. The personal identifying information is loaded into the translator, such that the health information is coupled to the personal identifying information but still offline. As a result the personal identifying information and the health information can only be accessed by the patient or by an authorized health provider.

### BRIEF DESCRIPTION OF THE DRAWINGS

FIG. 1 shows the prior art technique for on-line security.

FIG. 2 is a flow chart describing the instant system and method.

FIG. 3 is a flow chart describing the V-ID translator component of the system and method which serves as an offline record of patient information to complement a patient virtual ID or pin.

The flow charts and/or sections thereof represent a method with logic or program flow that can be executed by a specialized device or a computer and/or implemented on computer readable media or the like (residing on a drive or device after download) tangibly embodying the program of instructions. The executions are typically performed on a computer or specialized device as part of a global communications network such as the Internet. For example, a computer typically has a web browser installed within the CPU for allowing the viewing of information retrieved via a network on the display device. A network may also be construed as a local, ethernet connection or a global digital/broadband or wireless network or cloud computing network or the like. The specialized device may include any device having circuitry or be a hand-held device, including but not limited to a tablet, smart phone, cellular phone or personal digital assistant (PDA) including but not limited to a mobile smartphone running a mobile software application (App). Accordingly, multiple modes of implementation are possible and “system” as defined herein covers these multiple modes.

### DETAILED DESCRIPTION OF THE PREFERRED EMBODIMENT

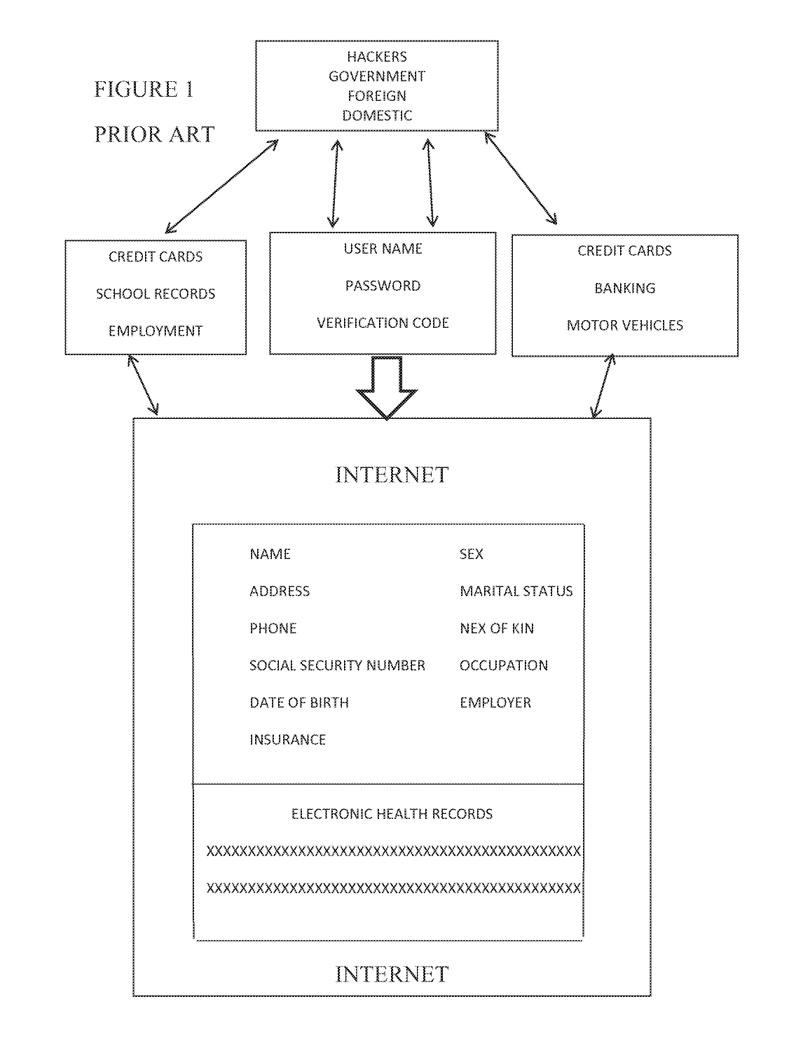

FIG. 1 shows the prior art technique for on-line security. The Internet has provided hackers, governments, foreign, domestic and research corporations with basically unfettered access to any and all personal information on citizens globally (i.e., credit cards, bank accounts, user's names, passwords, health and legal information) currently contained in data bases, social media and various Internet sites.

User names and passwords are the primary facades of protection for privacy and confidentiality. Often encryption technologies are included for additional deterrence against the intrusion of privacy. These security facades are usually neutralized by various technical expertise, devices and software. Once intruders are able to circumvent these pseudo barriers of protection, they have full unfettered access to any and everyone's most personal and sensitive information. The sources that can penetrate these barriers of protection are both illegal and legal. It is impossible for anyone's personal information to remain private, confidential or secure if it is deposited on line on any site on the Internet. There is no known technology that is sufficient to protect against intrusion of information deposited on the Internet.

The proposition of being able to have The Health Insurance Portability and Accountability Act of 1996 (HIPAA) Compliant, secure health records and sensitive information on line is a myth of epic proportions. If illegal intrusions were not sufficient to dispel the idea that any on line information is accessible, the Snowden disclosures of the government's legal access make it clear that Internet information and confidentiality is an oxymoron.

Virtual Identifications Procedures conceded that all Internet information is accessible. It assumes that the on line information can, and will be, accessed by a variety of sources. However if the information accessed cannot be matched to a specific person's identity, then the value of that information is diminished and the violation of the person's privacy and right of confidentiality is eliminated.

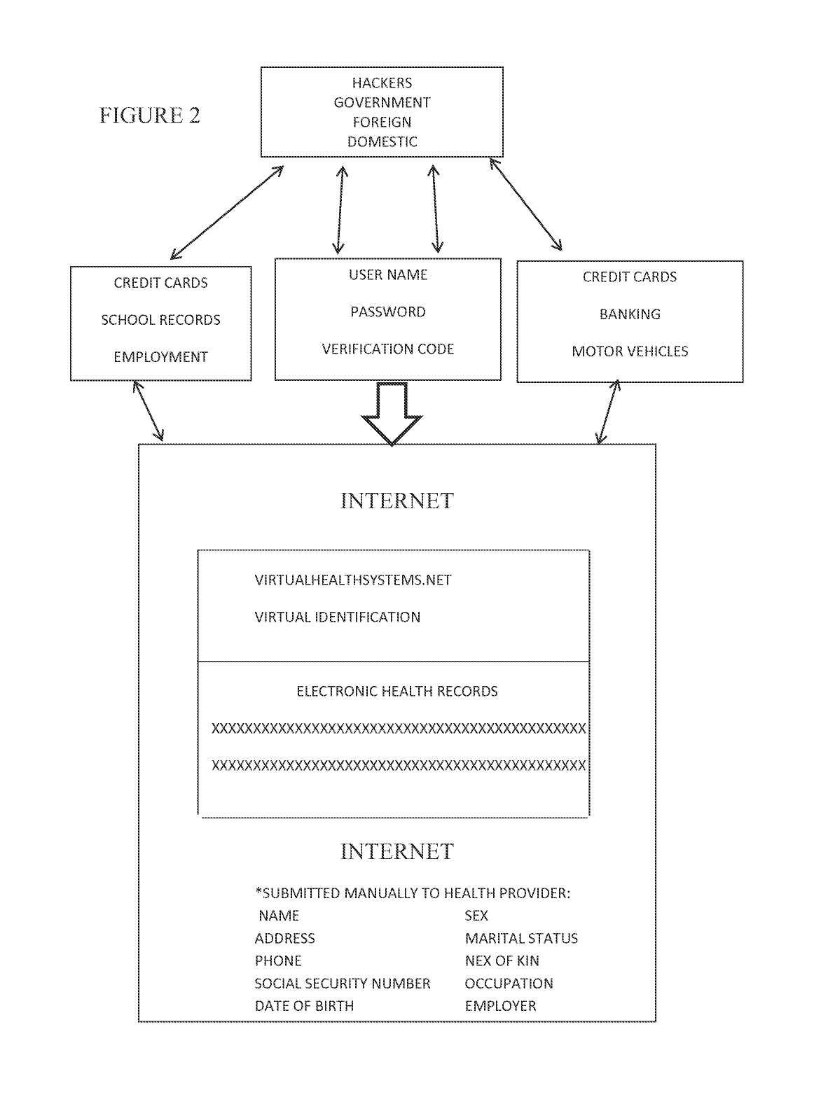

With reference then to FIG. 2, the application of the instant Virtual Identification protocol allows the person to take advantage of the benefits of having information on line without sacrificing their privacy. A Virtual ID, in combination with a translator hardware device, provides assurance that the only persons that can match the on line information with a specific person is the originator of the Virtual ID and those who they (the originator) have manually shared their Virtual ID with. In addition, the virtual ID can be used to extract and store personal health information offline, such that only the patient and designated health provider can have unfettered access to the personal health information, as follows.

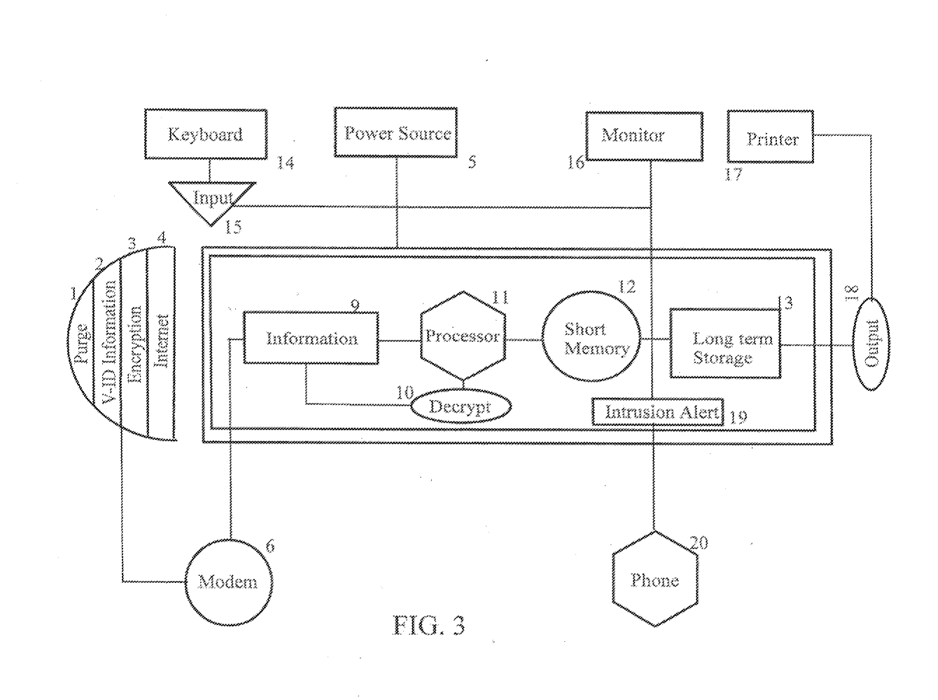

Now referencing more specifically FIG. 3, shown is the overall, diagrammatic illustration of the instant system and method in part hosted on a network server, accessible over the Internet 4. “Site” 40 as used herein means the network server or website hosting the information and accessible over a global communications network such as the Internet 4. The information exchanged from the site 40 is personal health information (or V-ID information 2) and other personal identification information and codes which are inputted into the site 40 for accessing the personal V-ID information 2. The goal of the site 40 is to host information and constantly scrub the information, then allow for the viewing and downloading of the information to an offline device. The offline device, termed herein translator hardware device 30, is then used as the mechanism to share the information rather than the network/Internet 4 itself. Thus, referencing again FIG. 3, item 30 represents the translator hardware device 30 in communication with the site 40 and ancillary hardware devices working in conjunction therewith, e.g. keyboard 14, modem 6, etc. All Patient information on the SITE site is accessible via the World Wide Web and Internet 4 wherever and however the Internet is available. The patient's online information is accessible in whatever form or configuration it has been entered and maintained online. After logging in, the Patient enters a V-ID code onto the SITE site to prepare for transfer to V-ID Translator.

A case sensitive, alpha numeric, personal identification number, termed herein VIRTUAL ID (VID) is manually created for purposes of accessing personal health information, or V-ID information 2. Personal health information or V-ID information 2 refers to medical, clinical health information text, V Email or any available information transmitted online to or from, the site. This information, as instructed, should be void of any personal identification information, (ie, names, social security numbers, date of birth, race, etc.), thus the distinction between personal health information and personal identification information. The VID is created by a person to protect their personal health information 2 that is deposited on line and otherwise accessible via the Internet 4. The VID is created manually off line by the person and is only known to other persons that the originating person consents to share it with (i.e. Health Professionals and close family members). The VID is used exclusively by the person to extract the online, personal health information 2, however any sharing or association with the Virtual ID and the person's actual identity, is only done manually off line, as further described. It is the absolute separation between their on line ID and off line identity that enables the Virtual ID to be a valid and valuable source of protection for the person's personal health information 4 and true identity.

In order for the Virtual ID to retain its value, the individual must adhere to very specific and strict practices and procedures to ensure and maintain the separation of the Virtual ID from all and any other forms of off line identification (i.e., credit card, driver's license, social security number, address, etc.). The personal Virtual ID sources can only be associated with the Virtual ID manually by the person, their Health Provider and other person's designated by the Patient and matched off line manually, to confirm the person's identity with any on line record and information, including the user's name and passwords, thereby maintaining its value. The Virtual ID cannot be used with other on line services that request and include personal identification information; to do so would connect and associate the Virtual ID with that person's unique identifying information thus compromising the integrity of the Virtual ID. In addition to the Patient's not using any personal identifying information to protect their identity, all health information and text communication will be encrypted by any standard encryption process 3. All information 2 online will be encrypted 3 and can only be deciphered by Patient or Provider by entering the V-ID number 2. The information deciphered online is only valuable to the Patient, their Provider and others who can definitively associate this information with the Patient.

Site 40 has purge software 1 running concurrently and constantly in the background of the site. Purge software 1 is a means for redacting any personal identifying information that may inadvertently be entered into person's online clinical record, text or v-mail information (personal health information). This program is designed to detect and expunge names, addresses, dates of birth, and all personal identifying information that a person may accidently include in their personal health records and communications. The purging software 1 will run silently in the background on the SITE site, functioning by continually scanning and automatically removing (scrubbing) any personal identifying information online (name, age, DOB, sex, race address, etc.) from the patients medical record, v-mail or text information transmitted or received on the site. It will also serve as the mechanism for automatic updates and modifications on the site 40.

Referencing the V-ID pin, an alphanumeric name is created consisting of, for example but not limited thereto, at least six (6) characters that take the place of the user's name. This Virtual Identity should only be shared and used for communications with health providers. It should never be used with Patient's real name, address, social security number, driver or professional license numbers, date of birth, military ID, username, passwords or any other form of identification that would allow even the most remote association with a Patient's real name and or identity. It should not be stored on a person's computer, cell phone or any electronic device that can be accessed via the internet or that would allow it to be associated with a person's real identity. It should only be shared with the person's health Provider, close relatives and those who have a need to know in the event of an emergency.

In a manual process of information exchange, the Virtual ID can be given to providers manually in person, via fax, or mail only, not by e-mail, text or any device that transmits via the internet. It is preferred that no part of the user's first, middle or last name be used on any Health Provider communications or documents at any time with anyone.

Health Providers are obligated to retain your VID physically, off line, in files, folders, patient logs and registers or offline devices in secure, locked and/or restricted access locations.

All patient VIDs along with their online health information, will be programmed into the offline software and translator device (See FIG. 3). The Patient's information can be retrieved by entering the proper password and VID.

Providers will use their access to Patient's Virtual ID to verify a patient/client's identity for clinical contact, administrative and billing to third parties. Providers will serve as an identification liaison for other third parties (Insurance, employers, and family, legal and other clinical sources) that have a need to know a patient's health information that may have originated on line via the BEMR. Only under authorized written consent from the patient and special circumstances of law will site providers share or surrender a patient's Virtual ID to any third party. Any third party source clinical or legal should only need to verify the person's name, social security number, clinical history and status which the provider may, or may not, submit in accordance with state and/or federal regulations and law.

At this time there are no circumstances that would require the provider to surrender a patient/client's Virtual ID. Implementing Virtual ID procedures means that even when a patient's information is surrendered to a third party; it will be a limited and not a global exposure to the community of internet users.

In a more automated, but still offline method for personal health information exchange, and referring again to FIG. 3, the translator hardware device 30 and indicated procedures minimize intentional and unintentional actions by the provider or their staff that would compromise confidentiality of the patient's Virtual ID. These procedures increase the security and benefits of the VI for health information beyond internet intrusions.

The translator hardware device 30 (also referred herein as translator) is an electronic housing powered, for example, by an outlet or battery power source 5. The translator hardware device 30 is designed to operate as a reader exclusively for the purpose of creating an offline record and database of a patient's online information. It stores and secures a patient's health information; the information can only be downloaded from the Internet to the translator 30 manually by the patient or their authorized representative using their user name, password, and Virtual ID. The patient's name, social security number and other necessary personal information such as address, insurance coverage and ID information will be matched and programmed into their health record contained in the translator 30. In addition to their password, the health provider will be required to enter the patient's Virtual ID in order to access the patient's health record information.

More particularly, housing 31 is any type of outer casing containing the hardware and software components. Once translator hardware device 30 is turned on it may be connected via USB to any network device hosting the Site 40. Network, as above, means a local, ethernet connection or a global digital/broadband or wireless network or cloud computing network or the like. The device may include any device having circuitry or be a hand-held device, including but not limited to a tablet, smart phone, cellular phone or personal digital assistant (PDA) including but not limited to a mobile smartphone running a mobile software application (App). Server as is known means a system that responds to requests across a computer network to provide, or help to provide, a network service. Therefore network device and network server means the combination of the above.

Translator software will be poised for authorized PIN and V-ID code to activate modem 6 and start downloading the patient's encrypted information 2, 3 into the translator hardware device 30. Translator V-ID software directs, manages, and executes sequence of events effecting the downloaded information in the translator hardware device 30. The encrypted information 9 will be deciphered (decrypted) and transferred to processor 11. The processor 11 will take the deciphered information 9 and transfer to translator's short memory 12. Information in short memory 12 will be edited, modified and otherwise managed before transferred to long term storage 13. Short term memory operates “OFFLINE” and serves as the device workshop, allowing access to the ONLINE information that has downloaded from the site 40 to the V-ID Translator 30 or information retrieved from the translators long term storage 13. The offline information in short term memory can then be modified to include personal identifying information, amended and otherwise edited before being transferred to long term storage 13. Long term storage 13 will maintain the modified information for access by provider, Patients and authorized staff as output 18. Translator keyboard 14 is used to transmit commands as input 15 that will enable patient/provider to manage information in short memory 12 and long term storage 13. The input 15 will screen and filter commands and instructions entered. If the information entered is incorrect or in error or unauthorized, the intrusion alert 19 will be activated. The intrusion alert 19 will transmit information regarding errors and attempts of unauthorized access to translator hardware device 30 information. The alerts will appear on the translator's monitor 16 and can ring to an analog phone or unlisted phone or any other device used exclusively to receive alerts. Any unauthorized access or attempts to access a health record will trigger this alert that will indicate on the Translator's screen or alert button, and transmitted via phone call to a designated red alert number programmed into the translator 30. The translator 30 will also shut down until reset by the responsible Provider. Any unauthorized attempts to access the information in the device activates an automatic re-encryption of all information in short and long term storage and a total shutdown of the device.

The monitor 16 will visually display information activity associated with the translator hardware device 30 and any alerts, errors, or alarms. The printer 17 will create a physical copy of text or image of information processed, managed, and maintained by the translator hardware device 30. Output 18 will transmit information from the translator hardware device 30 to the monitor 16 and printer 17. The Translator will contain the contact information of a health proxy and secret code word to authorize the emergency release of health information in health emergencies and situations where the Patient is not able to provide the necessary authorization. The Translator VID software is designed to block any modifications or attempts at unauthorized access, or to make the information transferable or transmittable online or via the Internet.

Accordingly, the Virtual Translator (VT) or translator hardware device 30 is a device that is specially and specifically designed to be used by health providers to access and compliment the confidentiality of the Virtual ID information offline (See FIG. 3). Unlike a traditional drive, translator 30 does more than transfer and store memory. Translator 30 allows for applying identification of otherwise unidentifiable and encrypted information downloaded from the internet, stores personal health information in an ultra secure environment with access to the information restricted to the patient, their health provider and others designated to have access, and allows for the deciphering, encryption, editing, modification and complete management of the patients health information in a specially secure and safe environment. The translator 30 is equipped with offline software specifically designed to download the Patient's health record information from the Internet while maintaining and reinforcing the confidentiality of that information. Translator “OFFLINE” software refers to a means for securely extracting online information from the site 40 and manage all functions and information in the translator 30. It serves as master control for all user and password authorization and access to the information in the translator 30. Software of translator 30 serves as the master control for processing, deciphering, transferring, retrieving, editing, storing and securing all information contained in the device. Once the health record information 9 is downloaded to the translator 30, the provider will verify the patient's identity via social security, driver's license, passport, and other Photo ID. Upon verification, if they have not already done so, the patient will create a virtual ID that they will share with the provider. They may also provide answers to three security questions which will be part of their identity verification and security profile that will be contained in the translator health profile. Under ordinary circumstances access to the patient's health record via the translator 30 will only be known to the provider and designated clinical personnel and staff (i.e. head nurse, office manager, and designated consultants).

The provider will be required to maintain a manual copy and log of all patients' Virtual ID numbers. Providers will have administrative control to allow access to translator 30 information via passwords distributed to selected staff. The translator 30 is programmed to automatically record the date, time and password for any access to a patient's health record. The log will be reviewed daily by the provider or authorized administrator for quality assurance.

The Patient's name should be used with any offline clinical folders and files (i.e, Intake information) that is physically maintained in the provider's office or possession. This procedure minimizes intentional, and unintentional, actions by the provider or their staff that would compromise confidentiality of the patient's Virtual ID. These procedures increase the security and benefits of the VID for health information beyond internet intrusions.

Providers will use their access to patient's Virtual ID register to verify a patient/client's identity for clinical contact, administrative and billing to third parties. Providers will serve as an identification liaison for other third parties (Insurance, employers, and family, legal and other clinical sources) that have a need to know a patient's health information that may have originated on line via the BEMR. Only under authorized written consent from the patient and special circumstances of law will site providers share or surrender a patient's Virtual ID to any third party. Any third party source clinical or legal should only need to verify the person's name, clinical history and status which the provider may, or may not, submit in accordance with state and/or federal regulations and law.

At this time there are no circumstances that would require the provider to surrender a patient/client's Virtual ID. Implementing Virtual ID procedures means that even when a patient's information is surrendered to a third party; it will be a limited and not a global exposure to the community of internet users.

1. A virtual identification method, comprising the steps of:
allowing a patient to create, offline, a personal identification number;
providing said patient online access from a network device to health information related to said patient stored on a network server;
purging, constantly in background of said network server, personal identifying information from within said health information;
providing a translator hardware device for connection to said network server;
allowing said patient to enter said personal identification number into said translator, wherein said personal identification number is thereby provided offline;
upon authentication by said translator, allowing said patient to download said health information from said network server and store said health information within said translator hardware device, wherein said health information is thereby offline;
uploading said personal identifying information into said translator, such that said health information is coupled to said personal identifying information but still offline, as a result said personal identifying information and said health information can only be accessed by said patient or by a health provider authorized by said patient.

2. A virtual identification method, comprising the steps of:
creating, offline, a personal identification number;
accessing health information from a network device, wherein said health information is stored on a network server;
entering said personal identification number into a translator, wherein said personal identification number is thereby provided offline;
upon authentication by said translator, downloading said health information from said network server and storing said health information within said translator hardware device, wherein said health information is thereby offline;
coupling said health information with said personal identifying information within said translator, while still offline, as a result said personal identifying information and said health information can only be accessed by said patient or by a health provider authorized by said patient.

3. A virtual identification system, comprising:
a personal identification number for a patient;
means for providing said patient online access from a network device to health information related to said patient stored on a network server;
means for purging, constantly in background of said network server, personal identifying information from within said health information;
a translator hardware device for connection to said network server for receiving said personal identification number, wherein said personal identification number is thereby provided offline;
means for storing said health information within said translator hardware device, wherein said health information is thereby offline, as a result said personal identifying information and said health information can only be accessed by said patient or by a health provider authorized by said patient.

4. The method of claim 1, further comprising the step of requiring said health provider to maintain a manual copy of said personal identification number.

5. The method of claim 1, further comprising the step of allowing said translator hardware device to automatically shut down until reset by said health provider in response to an unauthorized attempt to access said health information.

6. The system of claim 3, wherein said translator hardware device further comprises a processor, short term memory, and long term storage, wherein said processor transfers said health information to said short term memory for editing and modification therein such that upon further transfer to said long term storage said health information can be accessed by said health provider.

7. The system of claim 3, further comprising an intrusion alert in communication with said translator hardware device for indicating unauthorized access attempts to said health information.
